(19) United States
(12) Patent Application Publication
(10) Pub. No.: US 2006/0266030 A1
(43) Pub. Date: Nov. 30, 2006

(54) Expansion motor

(76) Inventors: Jason David Solomon, Troy, OH (US); Peter R. Manyek, Highland, IN (US)

Correspondence Address: TAFT, STETTINIUS & HOLLISTER LLP, SUITE 1800, 425 WALNUT STREET, CINCINNATI, OH, 45202-3957, US

(21) Appl. No.: 11/200,853

(22) Filed: Aug. 10, 2005

Related U.S. Application Data
(60) Provisional application No. 60/600,167, filed on Aug. 10, 2004.

(51) Int. Cl. F02G 1/04

(52) U.S. Cl. 60/508

(57) ABSTRACT

An expansion motor that converts energy input from a source of pressurized gas, such as steam, into work on reciprocating pistons. The expansion motor can be driven by compressed gas, exhaust from another motor, or steam produced in a heat transfer device heated by exhaust from an industrial process. By expanding the pressurized gas, the expansion motor can extract energy from gas having a relatively low pressure and flow rate. The expansion motor can include a lubrication system whereby lubricating oil flows through internal bores in a rotating shaft in order to lubricate bearings joining the pistons to the shaft. A power generating method that uses a wind power or tidal power to compress air to drive the expansion motor, and a power generating method that uses heat from incineration of biomass material or municipal solid waste to produce steam in an evaporator coil to drive the expansion motor, are also claimed. Potable water can also be produced by the claimed methods.

### CROSS-REFERENCE TO RELATED APPLICATIONS

This application claims the priority of U.S. provisional application Ser. No. 60/600,167, filed Aug. 10, 2004, the disclosure of which is incorporated herein by reference.

### BACKGROUND

The present invention relates to a motor, and more specifically to an expansion motor that converts energy input from a source of pressurized gas into work on reciprocating pistons.

### SUMMARY

It is a first aspect of the present invention to provide an expansion motor including: at least one piston adapted to reciprocate upon application of force to the piston by pressurized gas, and a rotating member coupled to the piston such that the reciprocating motion of the piston causes the rotating member to rotate, where the pressurized gas is steam generated with the assistance of a heat transfer device in thermal communication with exhaust from an industrial process.

It is a second aspect of the present invention to provide an expansion motor including: at least one piston adapted to reciprocate upon application of force to the piston by pressurized gas, and a rotating member coupled to the piston such that the reciprocating motion of the piston causes the rotating member to rotate, where the pressurized gas is stored gas that was pressurized at an earlier time by the work output of a motor.

It is a third aspect of the present invention to provide an expansion motor including: at least one piston adapted to reciprocate upon application of force to the piston by pressurized gas, and a rotating member coupled to the piston such that the reciprocating motion of the piston causes the rotating member to rotate, where the pressurized gas is received from the exhaust of a heat engine.

It is a fourth aspect of the present invention to provide an expansion motor including: at least one piston adapted to reciprocate upon application of force to the piston by pressurized gas, and a rotating member coupled to the piston such that the reciprocating motion of the piston causes the rotating member to rotate, where the pressurized gas is extracted from an underground reservoir.

It is a fifth aspect of the present invention to provide an expansion motor including: at least one piston adapted to reciprocate upon application of force alternately to first and second opposing surfaces of the piston by pressurized gas, a rotating member coupled to the piston such that the reciprocating motion of the piston causes the rotating member to rotate, a first valve adapted to control the admission of pressurized gas to a chamber adjacent to the first opposing surface of the piston, a second valve adapted to control the exhausting of gas from the chamber adjacent to the first opposing surface of the piston, a third valve adapted to control the admission of pressurized gas to a chamber adjacent to the second opposing surface of the piston, and a fourth valve adapted to control the exhausting of gas from the chamber adjacent to the second opposing surface of the piston.

It is a sixth aspect of the present invention to provide an expansion motor including: at least one piston adapted to reciprocate upon application of force to the piston by pressurized gas; a crankshaft having a crankpin affixed to the crankshaft off the center of rotation of the crankshaft, the crankpin coupled to the piston such that the crankshaft rotates in response to the reciprocating motion of the piston; a bearing located at the point of coupling of the piston and the crankpin; where the crankshaft includes a cavity bored therein, the cavity having a first orifice in fluid communication with a source of lubricating oil, and the cavity having a second orifice in fluid communication with the bearing; such that lubricating oil can be delivered to the bearing.

It is a seventh aspect of the present invention to provide a method for expanding a gas to convert internal energy of the gas into mechanical work, including the steps of: (a) opening a first valve to admit pressurized gas to a first chamber adjacent to a first surface of a piston, thereby allowing the pressurized gas to apply a force to the piston in a first direction; (b) at the time of step (a), opening a second valve to allow gas to escape from a second chamber adjacent to a second surface of a piston, wherein the second surface of the piston is opposed to the first surface of the piston; (c) closing the first valve to terminate the admission of pressurized gas to the first chamber; (d) allowing the pressurized gas in the first chamber to expand as it continues to apply a force to the piston in the first direction; (e) when the piston reaches the end of its stroke such that the first chamber is at its maximum volume, closing the second valve; (f) a short time following step (e), opening a third valve to admit pressurized gas to the second chamber, thereby allowing the pressurized gas to apply a force to the piston in a second direction opposite to the first direction; (g) at the time of step (f), opening a fourth valve to allow gas to escape from the first chamber; (h) closing the third valve to terminate the admission of pressurized gas to the second chamber; (i) allowing the pressurized gas in the second chamber to expand as it continues to apply a force to the piston in the second direction; (j) when the piston reaches the end of its stroke such that the second chamber is at its maximum volume, closing the fourth valve; and (k) repeating steps (a) through (j).

It is an eighth aspect of the present invention to provide a method of power generation including the steps of: (a) transferring heat from an industrial process to a heat transfer device in thermal communication with the exhaust from the industrial process; (b) vaporizing water to produce steam in the heat transfer device; (c) converting at least a portion of the steam's internal energy to mechanical work by expanding the steam against at least one reciprocating piston; and (d) connecting a load to a shaft that rotates in response to the reciprocating motion of the piston, thereby performing work on the load.

It is a ninth aspect of the present invention to provide a method of power generation including the steps of: (a) providing a windmill that performs mechanical work on a rotating shaft in response to wind; (b) compressing air in an air compressor that is driven by the shaft of the windmill; (c) storing the compressed air in one or more reservoirs; (d) converting at least a portion of the compressed air's internal energy to mechanical work by expanding the compressed air against at least one reciprocating piston; and (e) connecting a load to a shaft that rotates in response to the reciprocating motion of the piston; thereby performing work on the load.

It is a tenth aspect of the present invention to provide a method of power generation including the steps of: (a) providing a motor that performs mechanical work on a rotating shaft in response to movement of tidal waters; (b) compressing air in an air compressor that is driven by the shaft of the motor; (c) storing the compressed air in one or more reservoirs; (d) converting at least a portion of the compressed air's internal energy to mechanical work by expanding the compressed air against at least one reciprocating piston; and (e) connecting a load to a shaft that rotates in response to the reciprocating motion of the piston; thereby performing work on the load.

It is an eleventh aspect of the present invention to provide a method of treating nonpotable water, comprising the steps of: (a) injecting nonpotable water into a heat transfer device; (b) generating steam by applying heat to the heat transfer device to vaporize the water in the heat transfer device; (c) converting at least a portion of the steam's internal energy to mechanical work by expanding the steam against at least one reciprocating piston; (d) connecting a load to a shaft that rotates in response to the reciprocating motion of the piston; thereby performing work on the load; and (e) condensing the steam into water.

Other objects and advantages of the present invention will be apparent from the following description, the accompanying drawings, and the appended claims.

### BRIEF DESCRIPTION OF THE DRAWINGS

FIG. 1 is a schematic diagram of an application of the expansion motor according to an exemplary embodiment of the present invention.

FIG. 2 shows the heat transfer device including an evaporator coil into which water is injected by a venturi nozzle, according to an exemplary embodiment of the present invention.

FIG. 3 is a schematic diagram of an application of the expansion motor according to an exemplary embodiment of the present invention.

FIG. 4 is a perspective view of the expansion motor according to an exemplary embodiment of the present invention.

FIGS. 5 through 8 illustrate the operation of the valves during one cycle of the expansion motor according to an exemplary embodiment of the present invention.

FIG. 9 shows the mechanism for actuating the valves of the expansion motor according to an exemplary embodiment of the present invention.

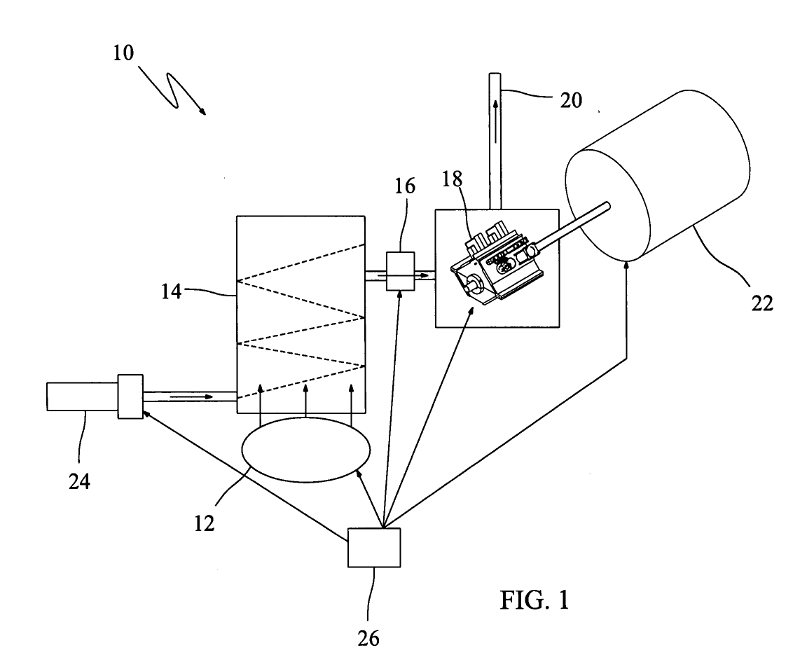

FIG. 1O is a perspective view of the camshaft of the expansion motor according to an exemplary embodiment of the present invention.

FIG. 11 shows the mechanism for actuating the valves of the expansion motor according to an exemplary embodiment of the present invention.

FIG. 12 is a perspective view of the crankshaft of the expansion motor according to an exemplary embodiment of the present invention.

FIG. 13 is a side elevational view showing the oil bores inside the crankshaft of the expansion motor according to an exemplary embodiment of the present invention.

FIG. 14 is an exploded view showing the bearing assembly for the scotch yokes of the expansion motor according to an exemplary embodiment of the present invention.

FIG. 15 shows the bearing assembly for the scotch yokes, with the outer ring held in place on the roller bearing by the spring clamps, according to an exemplary embodiment of the present invention.

FIG. 16 shows the bearing assemblies and scotch yokes seated on the crankshaft of the expansion motor according to an exemplary embodiment of the present invention.

FIGS. 17 and 18 are cutaway views showing the lubrication of the bearings for the scotch yokes via the oil bores in the crankshaft of the expansion motor according to an exemplary embodiment of the present invention.

FIG. 19 is a cutaway view illustrating the use of crossheads instead of scotch yokes to join the pistons to the crankshaft of the expansion motor according to an exemplary embodiment of the present invention.

### DETAILED DESCRIPTION

The present invention is directed generally to an expansion motor that converts energy input from a source of pressurized gas into work on reciprocating pistons. In an exemplary embodiment, the expansion motor is powered by steam, but any pressurized gas capable of expansion can be used.

FIG. 1 shows a schematic diagram of one embodiment of the present invention. The power generating system 10 uses heat from a heat source 12 to generate steam in a heat transfer device 14 such as coils, a heat exchanger, boiler, or other device. Water is supplied to the heat transfer device 14 by a feedwater device 24, which can be a feedwater pump or other device such as a venturi nozzle, as described below. Steam is generated in the heat transfer device 14 and flows through a control valve 16 before entering the expansion motor 18. In the expansion motor 18, the steam is expanded in the cylinders, thereby doing work on the pistons as will be described in detail below, after which the exhaust steam 20 leaves the motor. The expansion motor's power output is connected to an electrical generator 22. The system performance, including the feedwater device 24, throttle valve 16, steam pressure, and generator output, can be monitored and controlled using an electronic controller 26.

In the embodiment depicted in FIG. 1, the heat source 12 can be any source of heat, including heat from any combustion process or exhaust from any industrial process. For example, the heat source can be heat released from the combustion of biomass, such as wood and wood products, municipal solid waste (“MSW”), landfill gas created by the decomposing of landfill MSW, or animal wastes. In an alternative embodiment, the heat source can be heat released from any industrial process. For example, the expansion motor can be operated at a manufacturing facility using heat from a boiler on the premises or heat exhausted from a manufacturing process. Examples of possible industries where the heat source could be heat exhausted from a manufacturing process are pulp & paper, timber, steel/metal, and steel/metal preparation such as coke facilities.

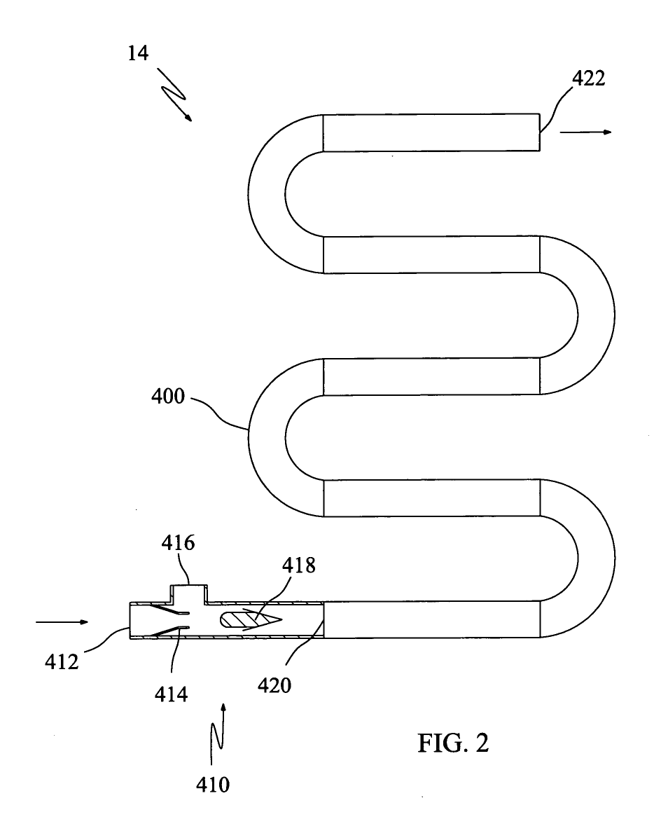

Because the expansion motor of the present invention can operate on relatively low gas pressures and flow rates, the heat transfer device 14 can be a device such as an evaporator coil that produces steam at a relatively low pressure, in contrast to a conventional heat exchanger or boiler, which typically operates at relatively higher pressures. Accordingly, in a detailed embodiment shown in FIG. 2, the heat transfer device 14 includes an evaporator coil 400 in which steam is produced. In the embodiment depicted in FIG. 2, the evaporator coil 400 consists of several straight sections of tubing joined by elbow connections to form a serpentine path, but the evaporator coil can have any shape and can have any number of tubing sections. The evaporator coil 400 is placed in the presence of the heat source 12 (as depicted in the FIG. 1 schematic diagram), and water is injected into the evaporator coil 400, where heat is transferred to the water to form steam. In an exemplary embodiment, a venturi nozzle 410 is used to inject the water into the evaporator coil. Water is supplied to the venturi nozzle 410 through inlet 412, and the water flow is increased as the water passes through the channel 414. Air is drawn in through port 416, and the air mixes with the water as the water forms turbulence while passing around the baffle 418. The resulting aerated water is then injected into the evaporator coil 400 through opening 420. After the water turns to steam, the steam exits the evaporator coil 400 through outlet 422. Alternatively, other devices and methods can be used to feed water into the heat transfer device.

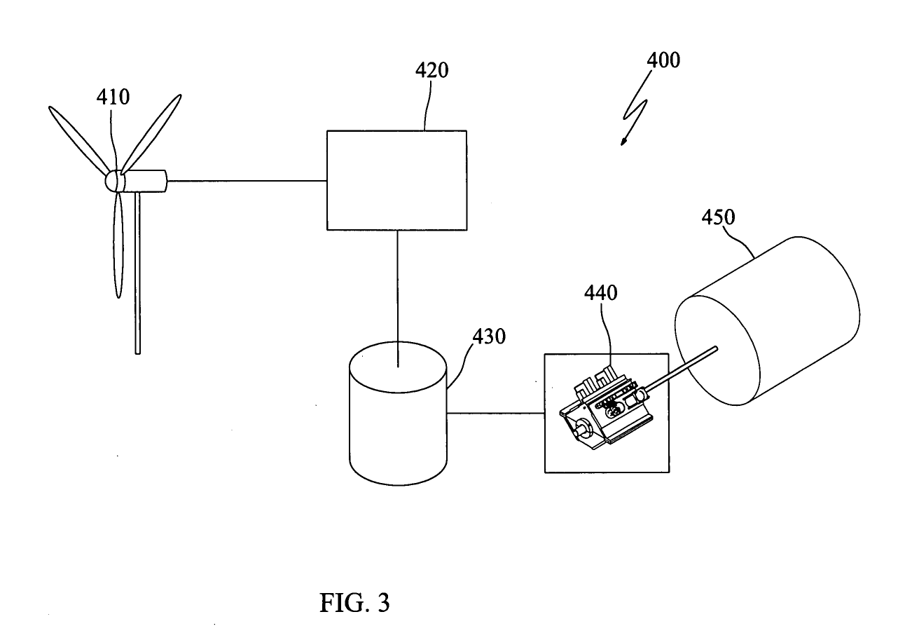

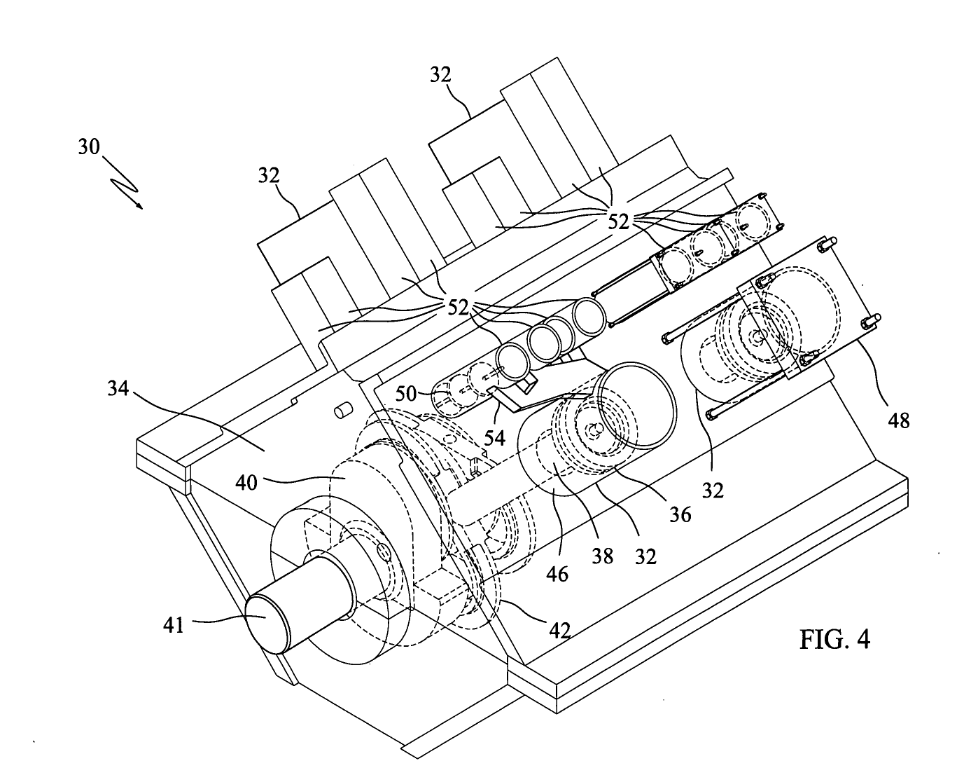

In another embodiment of the present invention, compressed gas other than steam, such as air, can be used to power the expansion motor. Any source of energy can be used to drive an air compressor, and the compressed air can be stored for later use. The stored compressed air can then be used to drive the expansion motor of the present invention, which can power an electrical generator or other load. Examples of energy sources that can be used to drive the air compressor include wind power and tidal power. FIG. 3 shows a schematic diagram of this embodiment 400 of the present invention, including windmill 410 driving an air compressor 420, which compresses air to be stored in reservoir 430, from where the compressed air is used to drive the expansion motor 440, which drives a generator or other load 450. This application has the advantage of being able to store the energy harnessed by a renewable source such as a windmill, which tends to have an uneven output level, in the form of compressed gas and release the stored energy by expanding the gas in the expansion motor of the present invention to generate electricity at an output level that is substantially constant over time, as is desirable for electricity generation. Alternatively, other sources of compressed gas, such as compressed carbon dioxide from an underground reservoir, natural gas compressed underground or in a pipeline, and geothermal gases, can be used to operate the expansion motor. Generally, any source of compressed gas, including the above-mentioned examples as well as gases exhausted from an industrial or manufacturing process, can by used to drive the expansion motor directly by expanding the gas in the cylinders of the expansion motor, without any need for a heat transfer device to produce steam. For example, the exhaust of another heat engine, such as an internal combustion engine or a steam turbine, can be expanded in the expansion motor to obtain additional energy from such gas.

The expansion properties utilized by this motor's operation, whereby the gas is expanded inside the cylinders before being exhausted, have the effect of cooling the gas to a lower temperature than the temperature at which the gas was supplied to the motor. In another embodiment of the present invention, this effect of the expansion motor allows the motor to be utilized to cool exhaust gases. For example, the expansion motor can be used in lieu of a cooling tower or other cooling device simply to cool hot gases, with some mechanical work being produced by the motor in the process. In the cooling process, some particulates can be condensed out and captured by filters.

In another application of the expansion motor's cooling effect, the motor can be used to treat nonpotable water, producing potable drinking water in addition to power output. Nonpotable water can be injected into a heat transfer device such as an evaporator coil and vaporized into steam (which would kill bacteria), as described above, with the resulting steam being expanded in the expansion motor. The steam can then be condensed into water, and this condensation step can occur, at least in part, inside the cylinders due to the cooling effect of the expansion. The condensed water output can then be filtered to remove any residual impurities, including impurities introduced by the motor. Minerals may be added to the water if desired. The resulting output is potable drinking water, in addition to the work output of the motor.

One of the primary advantages of the expansion motor of the present invention lies in its ability to run on gas supplied at a relatively low pressure (150 psig or less) and flow rate. This advantage allows the expansion motor to operate efficiently using renewable or discarded resources as an energy source (including exhaust heat recovery), and using a relatively inexpensive heat recovery device (such as the evaporator coils), as described above. In addition, the ability to run on gas supplied at a relatively low pressure and flow rate allows the expansion motor to operate efficiently using non-combustible pressurized gas from any source, as described above. In contrast, other power generating devices such as turbines require relatively higher gas pressures and flow rates, and as a result they typically require larger and more costly heat transfer devices such as boilers. Furthermore, these other devices typically require purified water to operate; in contrast, the expansion motor of the present invention can operate using gas containing particulates or other impurities. For these reasons, the expansion motor of the present invention allows economical use of renewable or discarded resources to generate power efficiently on a more local scale and in relatively low quantities, such as 2 megawatts or less, that would not be economically feasible using conventional power generating equipment. Additionally, because no combustion takes place inside the cylinders of the expansion motor, the expansion motor of the present invention provides a safety advantage over internal combustion engines that require volatile fuel to be stored and ignited at high internal pressures.

Generally, the size of the electrical generator that can be powered will be dictated by the size of the internal bores, pistons, and stroke lengths of the pistons of the expansion motor, as well as the operating pressure and gas flow rate. For example, a 4-cylinder, double-acting motor having a 6-inch bore and 6-inch stroke has been constructed and operated using 150 psig, 640° F. superheated steam at a speed of 900 rpm. In this operating configuration, the motor powered an 400 kW generator. In another application, a 4-cylinder, double-acting motor having a 3-inch bore and 3-inch stroke has been constructed and operated using pressurized natural gas at 150 psig and 180° F. at a speed of 900 rpm. In this operating configuration, this motor powered a 75 kW generator.

FIG. 4 is a perspective view of the expansion motor 30 according to an exemplary embodiment of the present invention. In the embodiment shown, this motor has four power cylinders 32 arranged in a V-4 configuration around an engine block 34. Different arrangements and numbers of cylinders can be used; for example, instead of a V-configuration, the cylinders can be arranged in an X-configuration, with cylinders positioned directly opposite each other in pairs. Referring again to FIG. 4, each power cylinder 32 contains a piston 36 whose piston rod 38 is connected to the crankshaft 40 by a scotch yoke 42 that fits over a crankpin (not visible in FIG. 3) on the crankshaft 40. The scotch yoke 42 transmits force from the piston rod 38 to the crankpin while allowing the crankpin to move in a circular motion as the piston rod 38 reciprocates. In the exemplary embodiment, the expansion motor is a double-acting steam engine, meaning that steam is applied to both sides of the piston. Thus, each power cylinder 32 has a cylinder head 46 at the bottom of the cylinder through which the piston rod 38 passes, as well as a cylinder head 48 at the top of the cylinder. The bottom cylinder head and the cylinder wall can be formed integrally with the engine block. The piston 36 preferably includes one or more seals to sealingly engage the inside wall of the power cylinder 32, thus preventing steam from leaking past the piston 36, and the bottom cylinder head 46 preferably includes one or more seals to sealingly engage the piston rod 38 (which passes through the bottom cylinder head 46), thus preventing steam from leaking past the bottom cylinder head 46.

With continued reference to FIG. 4, each power cylinder has four valves 50, each located in a separate valve cylinder 52. The valve cylinders can be formed integrally with the power cylinders, or they can be formed separately from the power cylinders and the other valve cylinders. Additionally, the valve cylinders can be oriented in any angular position relative to the power cylinders. For example, the valve cylinders could be positioned beneath, rather than above, the power cylinders in the view of FIG. 4. Each valve cylinder is connected to its power cylinder by a duct 54 through which the steam input or exhaust flows to or from the power cylinder. For each power cylinder, one valve controls the admission of steam to the upper chamber of the power cylinder (i.e. the side above the piston), one valve controls the exhausting of steam from the upper chamber, one valve controls the admission of steam to the lower chamber of the power cylinder (i.e. the side beneath the piston), and one valve controls the exhausting of steam from the lower chamber. The use of four separate valves to perform these four functions enables each event (admission or exhausting of steam) to be timed to occur at the appropriate point in the cycle for optimal efficiency. While piston-type valves are shown in the drawings and described herein, it is within the scope of the present invention to use other types of valves that are known to persons skilled in the art and are capable of controlling the admission and exhausting of steam or other gas.

Generally, each of the power cylinders 32 and its valve assemblies are similar in structure and function, while each can be joined to the crankshaft 40 at a different angular position in order to provide different stroke positions or phases for the different power cylinders. The end of the crankshaft 40 forms a drive shaft 41 that can be used to drive an electrical generator or other device.

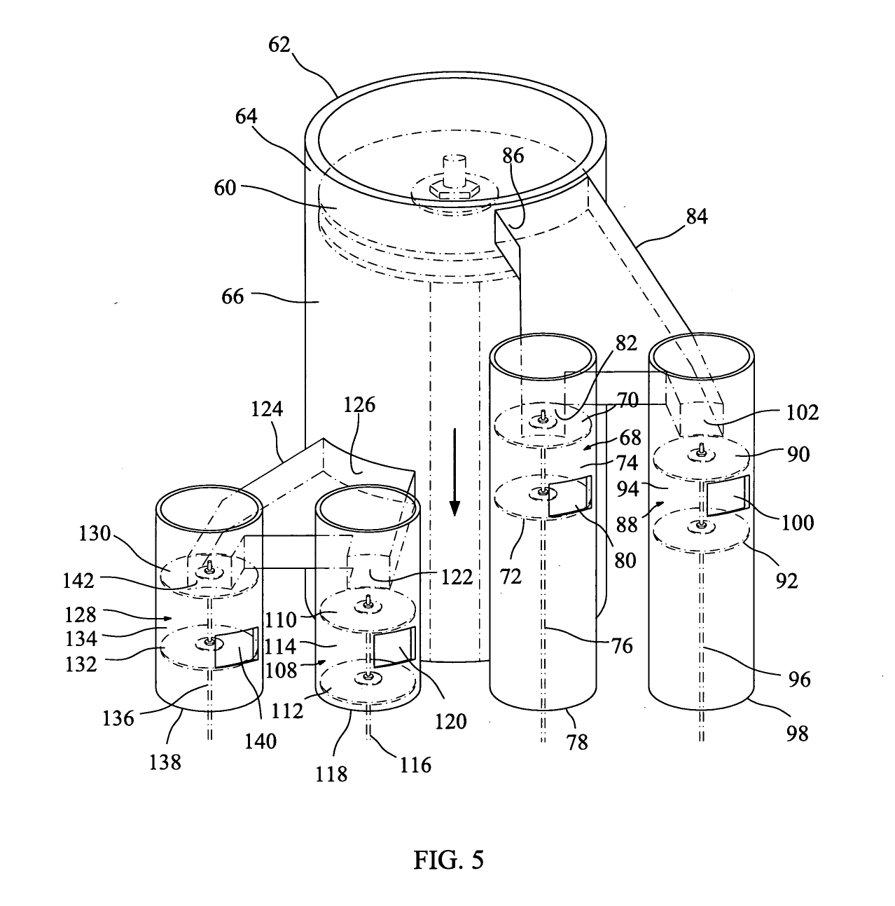

FIGS. 5 through 8 illustrate the operation of the valves to control the admission and exhausting of steam through one complete cycle of the power cylinder. With reference to FIG. 5, the various elements-of the valve-and-cylinder arrangement will be described first. This drawing shows one power cylinder and its four valves; it is understood that this operational description of FIGS. 5 through 8 applies to each power cylinder of the expansion motor. The piston 60 resides inside the power cylinder 62 and reciprocates in vertical direction within the power cylinder 62. The piston defines an upper chamber 64 within the power cylinder 62 above the piston 60, such upper chamber 64 being bounded by the piston 60 and by the top cylinder head (which is not shown in FIGS. 5 through 8 in order to avoid over-congestion in the drawings). The piston defines a lower chamber 66 within the power cylinder 62 below the piston 60, such lower chamber 66 being bounded by the piston 60 and by the bottom cylinder head (which is not shown in FIGS. 5 through 8 in order to avoid over-congestion in the drawings).

The four valve cylinders, each of which contains a valve for controlling the admission or exhausting of steam to or from one of the power cylinder's chambers, are visible in front of the power cylinder in FIG. 5. Each valve cylinder is capped by a cylinder head, which is not shown in these figures to avoid over-congestion in the drawings. For example, the upper chamber's admission valve 68 is located in the valve cylinder 78. The valve includes an upper surface 70 and a lower surface 72 defining an interior chamber 74. The two valve surfaces 70 and 72 are joined to a valve stem 76 that transmits force to the valve, causing the valve to slide vertically within the valve cylinder 78. The valve cylinder 78 has two ports in its cylinder wall: an intake port 80 that receives relatively high-pressure steam from the intake manifold, and an outlet port 82 that supplies the high-pressure steam to the power cylinder's upper chamber 64 through a duct 84 leading to a port 86 in the upper chamber's cylinder wall. The position of the valve 68 within the valve cylinder 78 determines whether the valve cylinder's intake port 80 and outlet port 82 are in fluid communication and, hence, whether the high-pressure steam will reach the power cylinder. The intake manifold that supplies the high-pressure steam input is not shown in these drawings (in order to avoid over-congestion in the drawings), and it can be in fluid communication with a throttle valve or a governor to regulate the mass flow rate or pressure of the steam input in order to control the speed of the motor. The throttle valve or governor can be implemented in a manner known to persons skilled in the art.

The other valve cylinders are configured similarly to the one described above. The upper chamber's exhaust valve 88 is located in the valve cylinder 98. The valve includes an upper surface 90, a lower surface 92, interior chamber 94, and valve stem 96. The valve cylinder 98 has an exhaust port 100 that delivers exhaust steam to the exhaust manifold, and a collection port 102 that receives the exhaust steam from the power cylinder's upper chamber 64 through a duct 84 leading to a port 86 in the upper chamber's cylinder wall. A single duct 84 and port 86 in the in the upper chamber's cylinder wall can serve both the admission and exhaust functions for the upper chamber, with the duct 84 having a forked shape to allow connection to both the admission valve cylinder (via port 82) and the exhaust valve cylinder (via port 102), as shown in these drawings. Alternatively, separate ducts and ports in the upper chamber's cylinder wall can connect to the admission and exhaust valve cylinders. The exhaust manifold that carries the exhaust steam away from exhaust port 100 is not shown in these drawings (in order to avoid over-congestion in the drawings).

In the same manner, the lower chamber's admission valve 108 is located in the valve cylinder 118. The valve includes an upper surface 110, a lower surface 112, interior chamber 114, and valve stem 116. The valve cylinder 118 has an intake port 120 that receives high-pressure steam from the intake manifold, and an outlet port 122 that supplies the high-pressure steam to the power cylinder's lower chamber 66 through a duct 124 leading to a port 126 in the lower chamber's cylinder wall.

Similarly, the lower chamber's exhaust valve 128 is located in the valve cylinder 138. The valve includes an upper surface 130, a lower surface 132, interior chamber 134, and valve stem 136. The valve cylinder 138 has an exhaust port 140 that delivers exhaust steam to the exhaust manifold, and a collection port 142 that receives the exhaust steam from the power cylinder's lower chamber 64 through duct 124 leading to a port 126 in the lower chamber's cylinder wall. As described above with respect to the upper chamber, a single duct 124 and port 126 in the in the lower chamber's cylinder wall can serve both the admission and exhaust functions for the lower chamber, with the duct 124 having a forked shape to allow connection to both the admission valve cylinder (via port 122) and the exhaust valve cylinder (via port 142), as shown in these drawings. Alternatively, separate ducts and ports in the lower chamber's cylinder wall can connect to the admission and exhaust valve cylinders.

With the valve components now defined, the operation of the valves through one cycle of the power cylinder can be described. In the view shown in FIG. 5, the piston 60 is near the top of the power cylinder 62, just beginning its downward stroke. The upper chamber's admission valve 68 is in the open position, meaning that it has been pushed upward so that its upper surface 70 has moved above the outlet port 82. Because this outlet port 82 and the intake port 80 are both exposed to the valve's interior chamber 74, these two ports are in fluid communication with each other. This allows the high pressure steam to flow into the intake port 80, through the valve's interior chamber 74 to the outlet port 82, through the duct 84 and port 86 into the power cylinder's upper chamber 64. This admission of high pressure steam into the power cylinder's upper chamber 64 will apply a force to the upper surface of the piston 60, pushing the piston downward.

In the downward stroke depicted in FIG. 5, the lower chamber's exhaust valve 128 is in the open position, meaning that it has been pushed upward so that its upper surface 130 has moved above the collection port 142. Because this collection port 142 and the exhaust port 140 are both exposed to the valve's interior chamber 134, these two ports are in fluid communication with each other. This allows the steam left in the lower chamber 66 from the previous stroke to flow from the lower chamber 66 into the cylinder port 126, through the duct 124 and collection port 142, into the valve's interior chamber 134 to the exhaust port 140. This disposes of the steam from the previous stroke, relieves the lower chamber 66 of backpressure, and prevents compression as the piston 60 makes its downward stroke. To accomplish these goals, the lower chamber's exhaust valve 128 will remain open until nearly the end of the downward stroke.

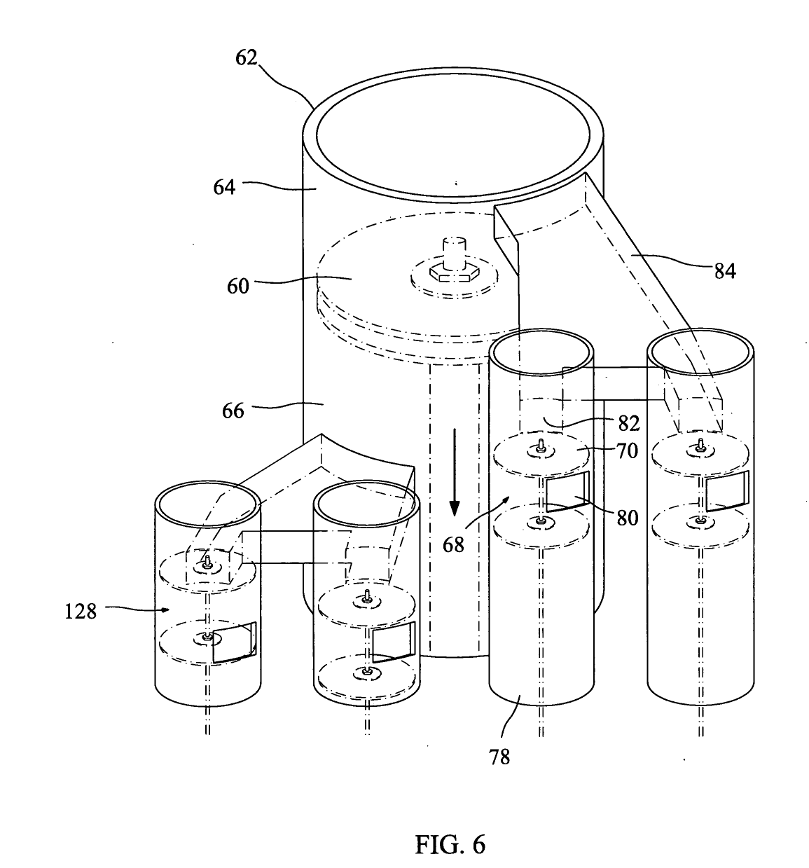

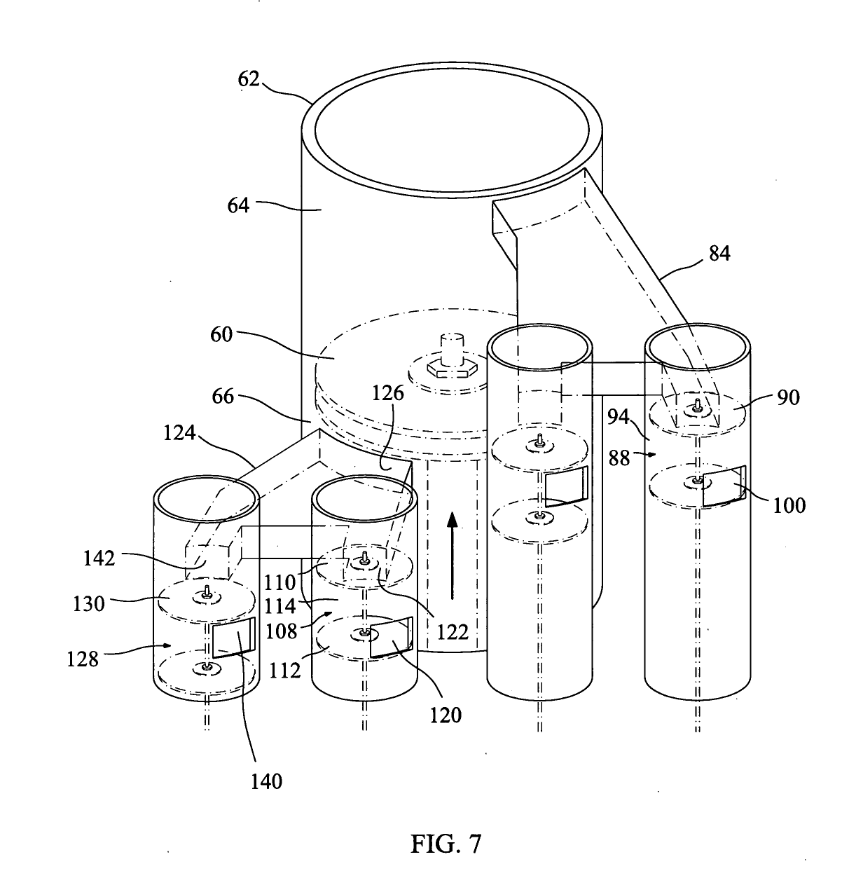

FIG. 6 shows the cylinder later in the downward stroke, at the point of cutoff. The piston 60 has moved part of the way down the power cylinder 62 under the force of the high-pressure steam being admitted into the upper chamber 64. At this point of cutoff, the upper chamber's admission valve 68 has been closed, terminating the admission of high-pressure steam to the upper chamber 64. This is accomplished by sliding the valve 68 downward in its valve cylinder 78 so that its upper surface 70 is now below the outlet port 82. The outlet port 82 (and hence the duct 84 leading to the power cylinder) is no longer in fluid communication with the intake port 80; thus, high-pressure steam from the intake port 80 can no longer flow to the power cylinder's upper chamber 64. No more high-pressure steam is being admitted to the upper chamber 64, but the steam already inside the upper chamber 64 continues to exert a downward force on the piston 60. As the piston continues to move downward under this force, the steam inside the upper chamber 64 expands, losing pressure and temperature as its energy is converted into work done on the piston. The ratio of the upper chamber's volume at full stroke (when the piston has moved to the end it its stroke, as depicted in FIG. 7) to the upper chamber's volume at the point of cutoff (as depicted in FIG. 6) is known as the motor's expansion ratio, and this number indicates the degree to which the steam is allowed to expand in the cylinder while doing work on the piston. In an exemplary embodiment, an expansion ratio of four is used, but the present invention can be implemented with other expansion ratios.

In FIG. 6, note that the lower chamber's exhaust valve 128 is still open, as discussed above. This valve will remain open during most of the downward stroke, allowing the steam inside the power cylinder's lower chamber 66 to be expelled as the lower chamber's volume decreases during the piston's downward movement.

In FIG. 7, the piston 60 has reached the bottom of the power cylinder 62 and has begun its upward stroke. The lower chamber's exhaust valve has closed, with its upper surface moving to isolate the duct 124 and collection port 142 from the exhaust port 140, thus preventing steam inside the power cylinder's lower chamber 66 from escaping. The lower chamber's admission valve 108 has been opened, which is accomplished by sliding the valve upward so that its upper surface 110 moves above the outlet port 122, thus bringing the outlet port into fluid communication with the intake port 120 via the valve's interior chamber 114. This allows high-pressure steam to flow into the duct 124 and port 126 into the power cylinder's lower chamber 66, where the steam will exert an upward force on the piston 60, pushing the piston upward.

As this upward stroke begins, the upper chamber's exhaust valve 88 is now open, having been moved so that its upper surface 90 is above the collection port 102, thus allowing the steam inside the power cylinder's upper chamber 64 from the just-completed downward stroke to exit the cylinder via the duct 84, the valve cylinder's interior chamber 94, and exhaust port 100.

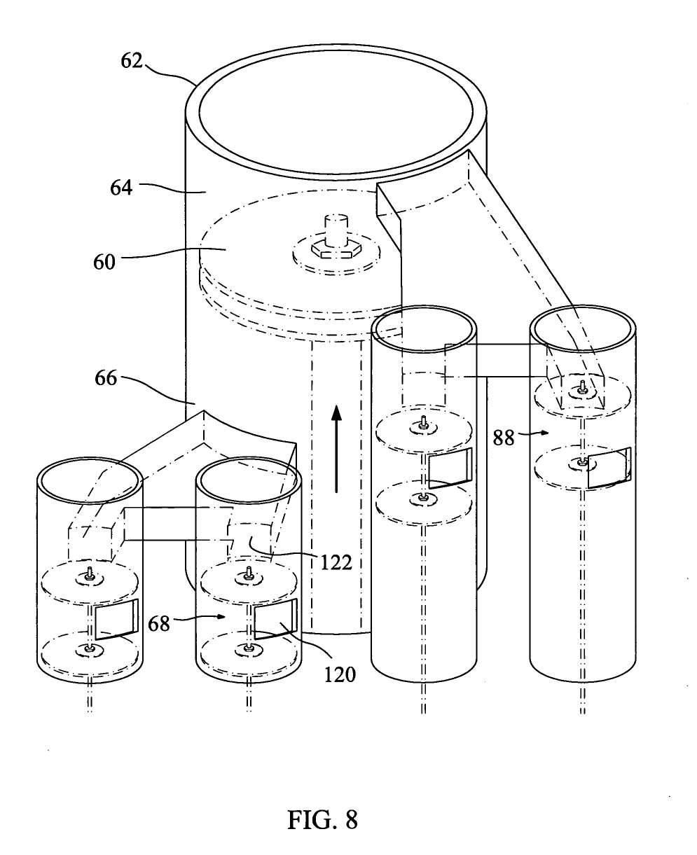

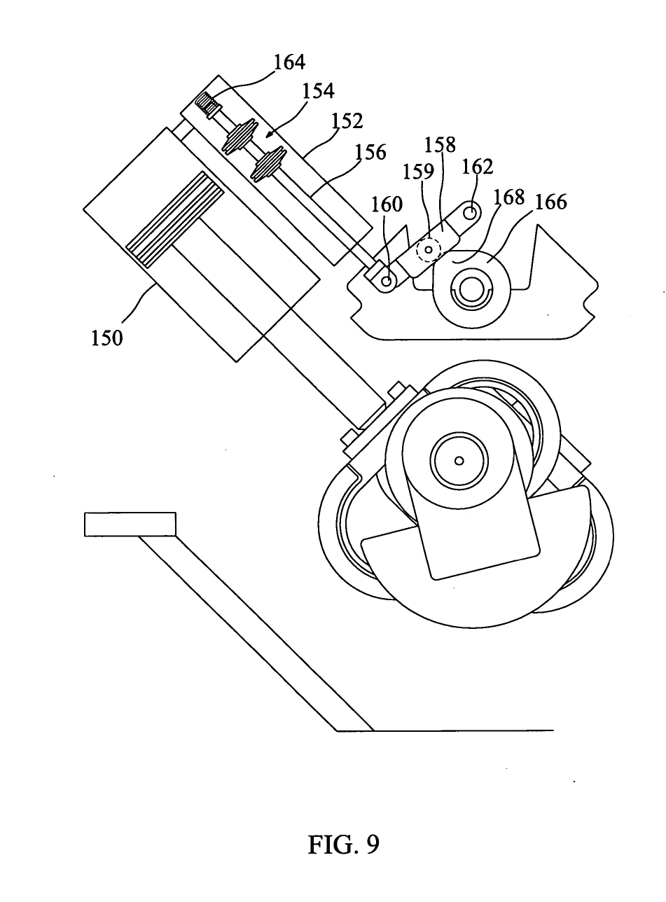

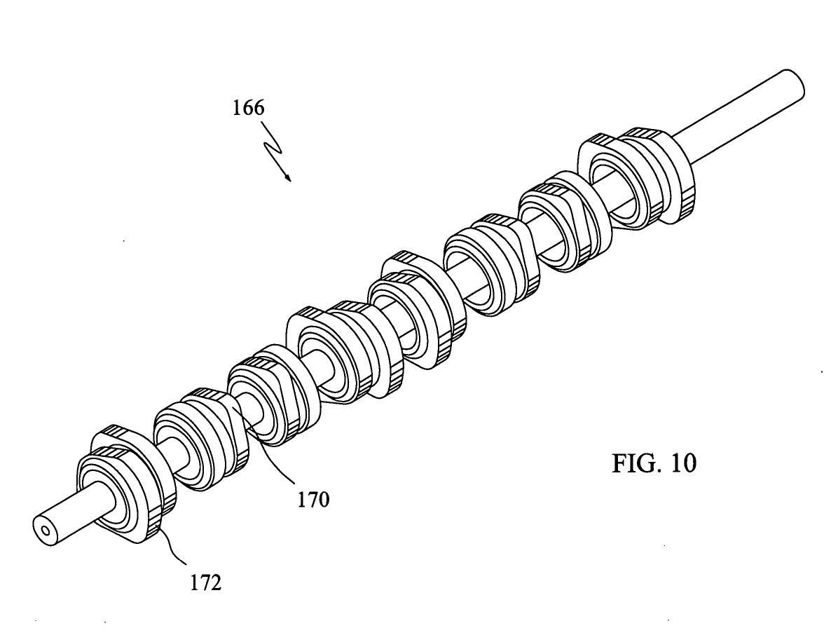

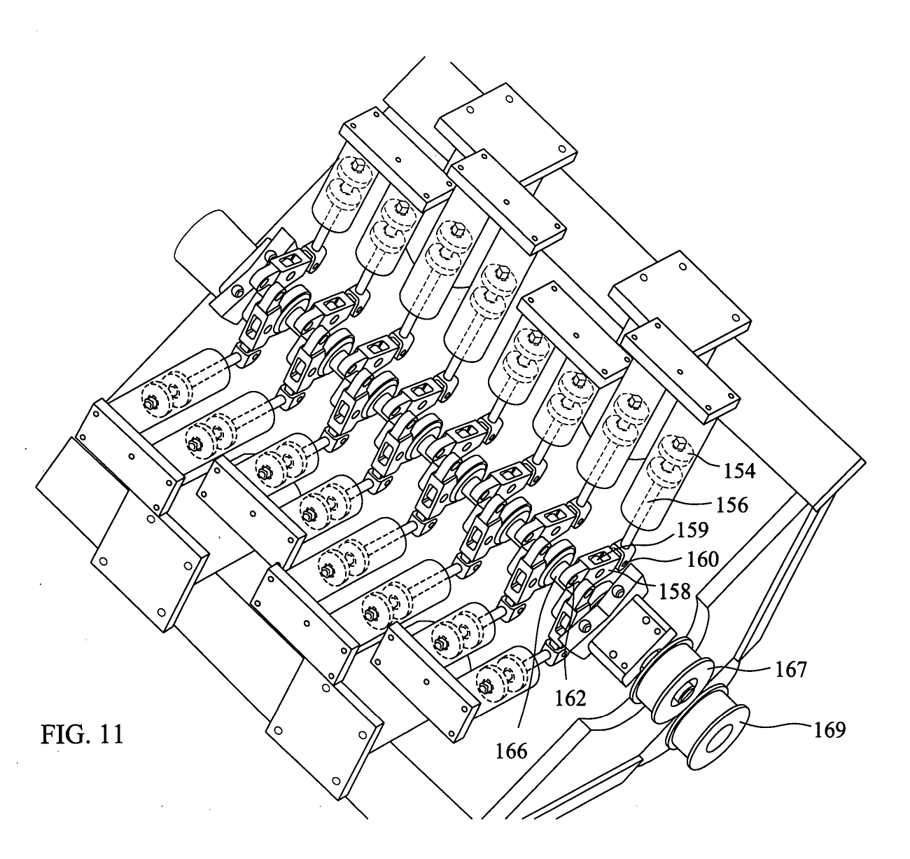

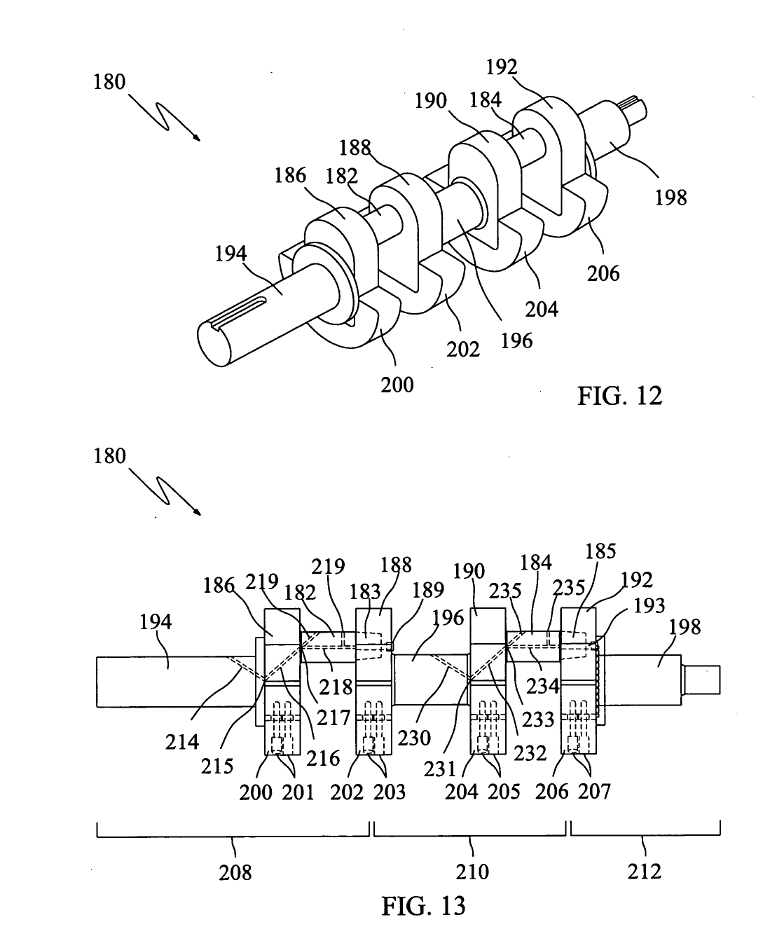

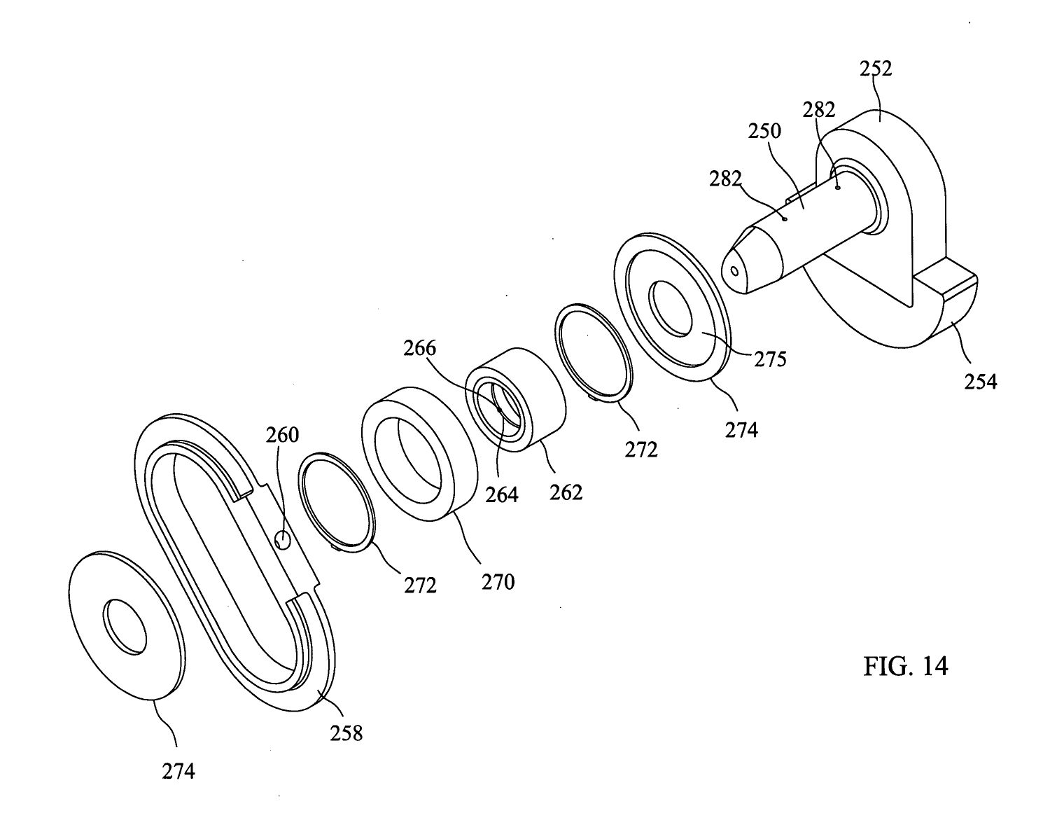

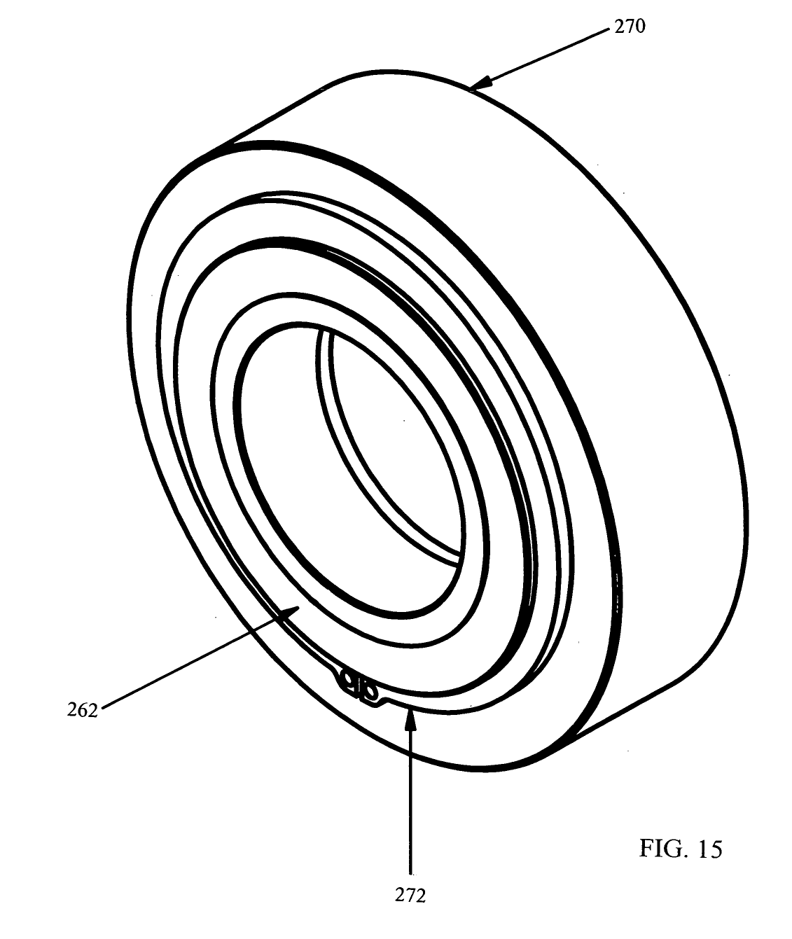

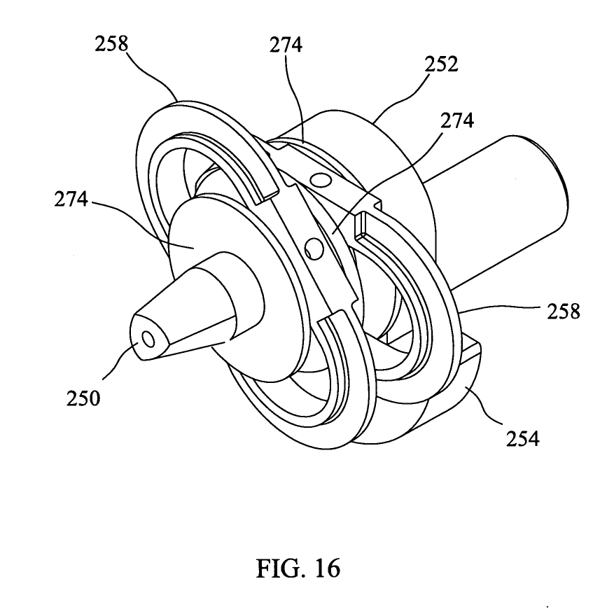

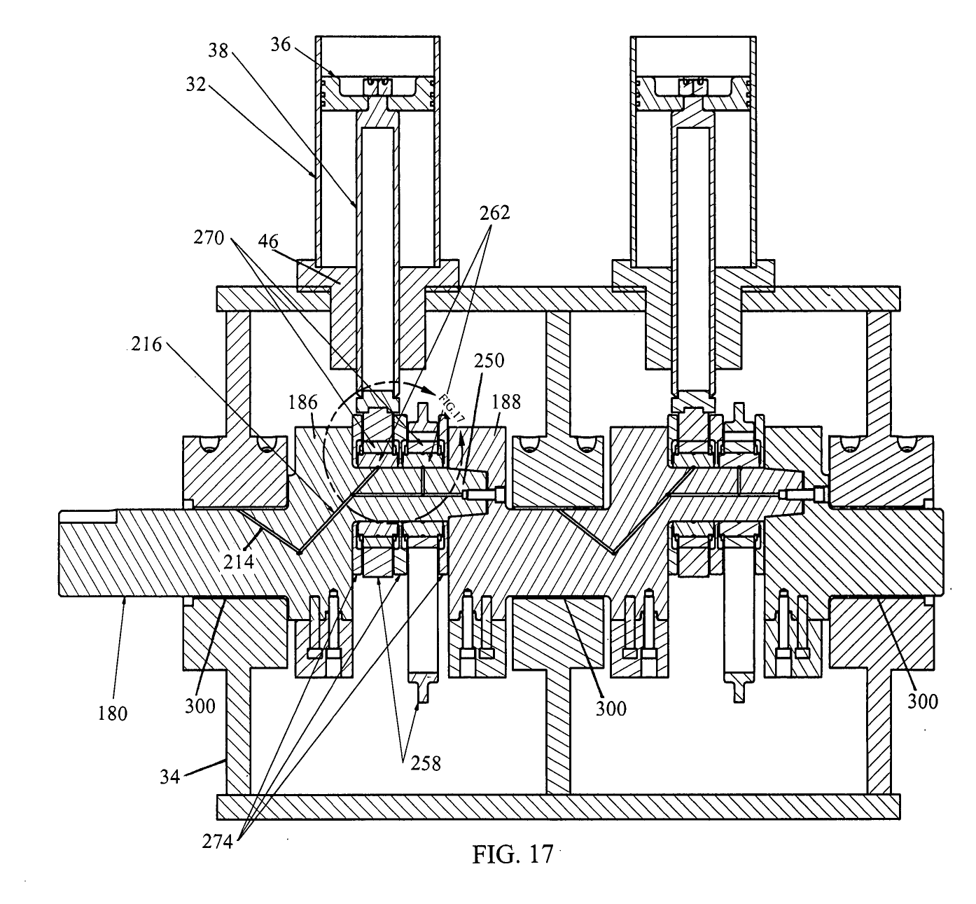

In FIG. 8, the piston is shown later in the upward stroke, at the point of cutoff. The piston 60 has moved part of the way up the power cylinder 62 under the force of the high-pressure steam being admitted into the lower chamber 66. At this point of cutoff, the lower chamber's admission valve 108 has been closed, terminating the admission of high-pressure steam to the lower chamber 66. As can be seen, the valve 108 has been moved so that the intake port 120 is no longer in fluid communication with the outlet port 122, thus preventing any more high-pressure steam from being admitted to the lower chamber 66. Nevertheless, the steam already inside the lower chamber 66 continues to exert an upward force on the piston 60. As the piston continues to move upward under this force, the steam inside the lower chamber 66 expands, losing pressure and temperature as its energy is converted into work

In FIG. 8, note that the upper chamber's exhaust valve 88 is still open. This valve will remain open during most of the upward stroke, allowing the steam inside the power cylinder's upper chamber 64 to be expelled as the upper chamber's volume decreases during the piston's upward movement.

When the piston 60 reaches the end of its upward stroke, the upper chamber's exhaust valve 88 will close, the lower chamber's exhaust valve 128 will open, and the upper chamber's admission valve 68 will open, beginning another cycle with the downward stroke.

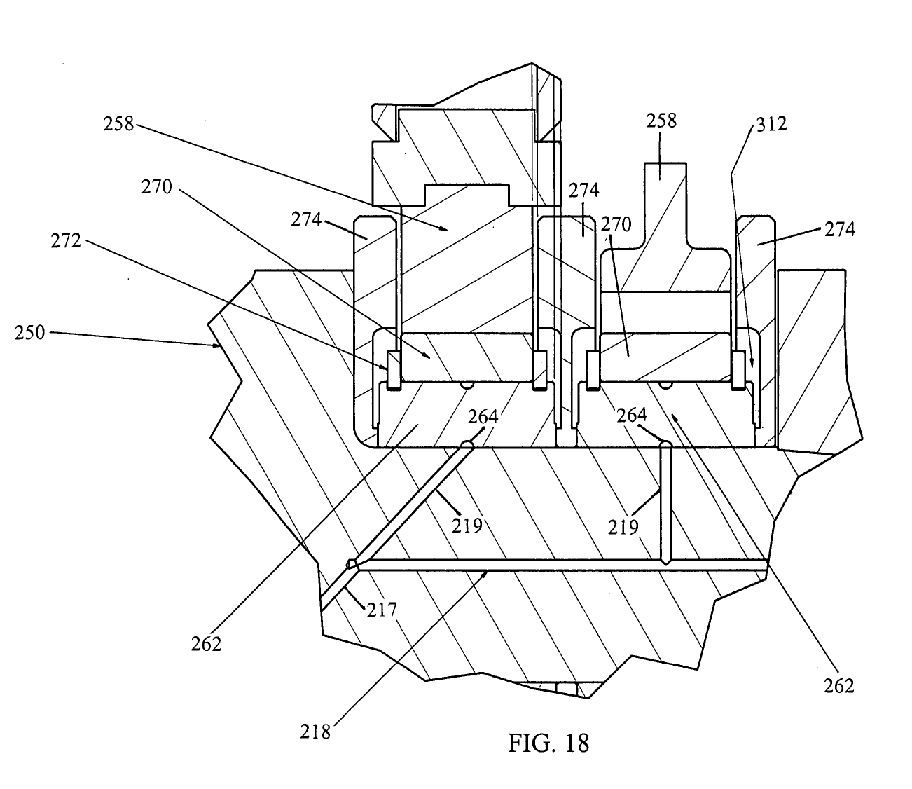

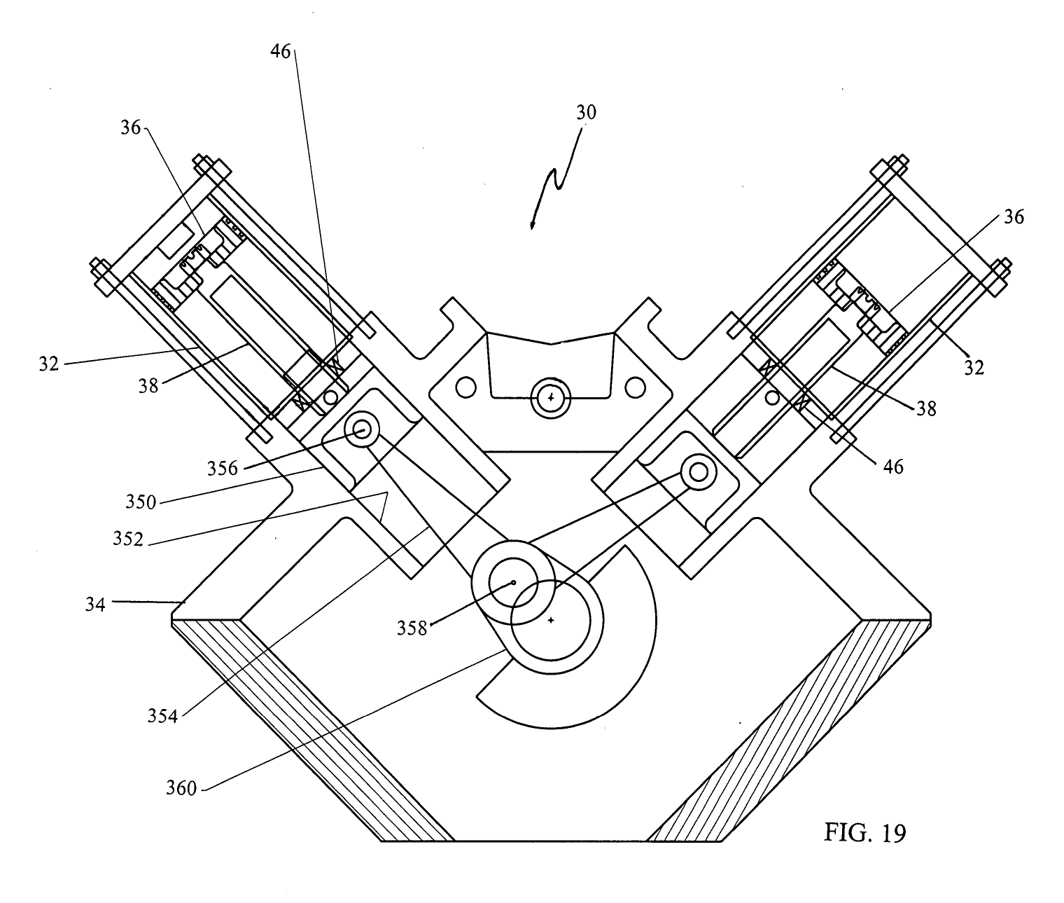

In the exemplary embodiment, each of the valves is actuated by a camshaft and rocker assembly, as shown in FIGS. 9 through 11. FIG. 9 is a cross-sectional view showing the valve gear mechanism. One of the power cylinders 150 is visible, along with one of its valve cylinders 152. Additional valve cylinders lie along the axis perpendicular to the plane of this drawing and thus are not shown. A valve 154 resides inside the valve cylinder 152. The valve includes a valve stem 156 that is pivotally connected to a rocker arm 158 at a point 160. The other end of the rocker arm 158 is pivotally connected to a fixed point 162. A spring 164 exerts a downward force on the valve 154, holding the valve is its normally-closed position. The valve is actuated by a rotating camshaft 166 containing a cam lobe 168 (a region of extended radius on the camshaft) for each valve. The rocker arm 158 includes a roller 159 that is joined to the rocker arm on an axis perpendicular to the plane of FIG. 9 and is capable of rotating about this axis. The roller 159 of the rocker arm 158 remains in contact with, and rolls along, the camshaft 166 due to the downward force exerted by the spring 164. When the camshaft rotates so that the raised cam lobe 168 meets the roller 159, the cam lobe 168 lifts the rocker arm 158 away from the axis of the camshaft 166, thus causing the rocker arm 158 to pivot about its fixed attachment point 162. As a result of the rocker arm's pivoting motion, the point of attachment 160 between the rocker arm 158 and the valve stem 156 is pushed upward toward the valve 154. The valve 154 thus slides upward in its valve cylinder 152, moving the valve to its “open” position, as explained above with reference to FIGS. 5 through 8. When the camshaft 166 rotates so that the raised cam lobe 168 is no longer in contact with the roller 159 of the rocker arm 158, the spring 164 returns the valve 154 to its initial “closed” position. It should be noted that it is within the scope of the present invention to employ any type of valve gear mechanism that is known to persons skilled in the art and is capable of achieving the desired operation of the valves.

FIG. 10 is a perspective view of the camshaft 166, showing the different cam lobes. Each cam lobe operates one valve, and the cam lobe's profile and angular position on the camshaft determine when, and for how long, the valve will open. As discussed above with reference to FIGS. 5 through 8, the admission valve for each power cylinder chamber opens at the beginning of each stroke and remains open for only a part of the stroke's duration, thus allowing the steam to expand inside the cylinder after the admission of high-pressure steam is cut off. Thus, the cam lobe for an admission valve will have a profile resembling the cam lobe 170 in FIG. 10, with a relatively small angular region of extended radius holding the valve open for a relatively short time. In an exemplary embodiment, this cam lobe profile has angular region of extended radius such that it holds the admission valve open for a duration substantially equal to one-eighth of the expansion motor's rotational period. In contrast, as discussed above, the exhaust valve for each power cylinder chamber remains open for nearly the entire downward or upward stroke, thus allowing steam to be expelled from the cylinder without compression as the piston is powered from the other side. Thus, the cam lobe for an exhaust valve will have a profile resembling the cam lobe 172 in FIG. 10, with a relatively large angular region of extended radius holding the valve open for a relatively longer time. In an exemplary embodiment, this cam lobe profile has angular region of extended radius such that it holds the exhaust valve open for a duration substantially equal to one-half of the expansion motor's rotational period.

FIG. 11 is a perspective view showing the valve gear, including valves, rocker arms, and camshaft, for a four-cylinder V-configuration expansion motor according to an exemplary embodiment of the present invention. The camshaft 166 is shown with a pulley 167 on one end. The camshaft can be driven by a belt coupling the camshaft's pulley 167 to a pulley 169 on the crankshaft. Alternatively, gears or other mechanical coupling devices can be used. In the exemplary embodiment, the camshaft is driven at the same rotational speed as the crankshaft, so that it makes one complete rotation for each rotation of the crankshaft. As seen in FIG. 11, an exemplary valve 154 includes a valve stem 156 that is pivotally connected to a rocker arm 158 at a point 160. The other end of the rocker arm 158 is pivotally connected to a fixed point 162. The structure forming this fixed point 162 is not shown in FIG. 11 (in order to avoid over-congestion in the drawings) but can be part of the engine block or other fixed member that is affixed to the engine block. The rocker arm 158 contains a roller 159 that is capable of rotating and rolls along the camshaft as the camshaft rotates, as explained above. Each of the engine valves in actuated by a mechanism having the components described herein with reference to this exemplary valve 154, and the rocker arms, valve stems, and attachment points for the other engine valves are visible in FIG. 11.

FIG. 12 shows a perspective view of the crankshaft 180 according to an exemplary embodiment of the present invention. In this exemplary embodiment, in which the expansion motor has four power cylinders arranged in a V-4 configuration, the crankshaft 180 has two crankpins 182 and 184 joined to lobes 186, 188, 190, and 192 off the center of rotation. Shafts 194, 196, and 198 are joined to the lobes on the center of rotation as shown, forming the rigid crankshaft structure. Each of the shafts 194, 196, and 198 is held in place by a bearing that is housed in the engine block structure. Counterweights 200, 202, 204, and 206 are affixed to each lobe diametrically opposite the crankpin, balancing the weight transferred to the crankpin by the scotch yokes attached thereto.

FIG. 13 is a cross-sectional view of the crankshaft 180. In the exemplary embodiment, the crankshaft 180 is formed in three sections. A left section 208 includes the shaft 194, the lobe 186 (to which counterweight 200 is fixed by bolts 201), and the crankpin 182. A center section 210 includes the lobe 188 (to which counterweight 202 is fixed by bolts 203), the shaft 196, the lobe 190 (to which counterweight 204 is fixed by bolts 205), and the crankpin 184. A right section 212 includes the lobe 192 (to which counterweight 206 is fixed by bolts 207), and the shaft 198. The left section 208 is joined to the center section 210 by a tapered end 183 of the crankpin 182, which fits into a recess in the lobe 188 having the same tapered profile. A bolt 189 holds the crankpin 182 and the lobe 188 together. Similarly, the center section 210 is joined to the right section 212 by a tapered end 185 of the crankpin 184, which fits into a recess in the lobe 192 having the same tapered profile. A bolt 193 holds the crankpin 184 and the lobe 192 together. In an exemplary embodiment, the tapered ends 183 and 185 of the crankpins have the shape of a Stoffel™ polygon.

With continued reference to FIG. 13, the crankshaft components include interior bores through which lubricating oil can flow, represented by the dashed lines within the components in this drawing. The left section 208 includes a bore 214 inside the shaft 194 that joins a bore 216 inside the lobe 186 at point 215, and a bore 218 inside the crankpin 182 that joins the bore 216 inside the lobe 186 at point 217. Bores 219 inside the crankpin 182 allow the oil to flow to holes in the surface of the crankpin 182, at which points the oil can lubricate bearings on the scotch yokes, as described below. Similarly, the center section 210 includes a bore 230 inside the shaft 196 that joins a bore 232 inside the lobe 190 at point 231, and a bore 234 inside the crankpin 184 that joins the bore 232 inside the lobe 190 at point 233. Bores 235 inside the crankpin 184 allow the oil to flow to holes in the surface of the crankpin 184, at which points the oil can lubricate bearings on the scotch yokes.

FIG. 14 is an exploded view showing the bearing assembly that joins the scotch yokes to the crankshaft, in an exemplary embodiment of the present invention. One crankpin 250 of the crankshaft is shown, along with the lobe 252 and counterweight 254 connected to the crankpin 250. The bearing 262 is a double roll, full complement, cylindrical roller bearing such as the SKF-NNF 5014 ADA-2LSV, or other bearing of like function, as will be known to persons skilled in the art. The bearing 262 has an oil groove 264 on its inner surface that is positioned in line with an oil hole 282 on the crankpin 250 when the bearing 262 is seated on the crankpin 250. The oil groove 264 allows oil to spread throughout the contact surface between the crankpin 250 and the bearing 262. Additionally, the inner surface of the bearing 262 features one or more oil holes 266 along the oil groove 264 to allow oil to reach the interior of the bearing and lubricate the rollers.

A ring 270 (of slightly less width than the bearing 262) is press-fitted over the outer surface of the bearing 262 to provide a stronger thrust surface for the scotch yoke 258 to act upon. The ring 270 is secured in place on the bearing 262 by a spring clamp or snap ring 272 that is tightly secured to the bearing 262 on either side, adjacent to the ring 270. This assembly, including the bearing 262, ring 270, and spring clamps 272, which is shown assembled in FIG. 15, is fitted over the crankpin 250. The scotch yoke 258 fits over the ring 270 and is held in lateral alignment by a thrust washer 274 that fits over the crankpin 250 on either side of the bearing assembly. A piston rod from one of the pistons would be joined to the scotch yoke 258 at point 260. The thrust washers 274 have an outside diameter substantially greater than that of the ring 270, thus allowing the thrust washers to serve as guides to prevent the scotch yoke 258 from slipping off the ring 270 as the ring 270 rotates and reciprocates within the scotch yoke 258. The thrust washer 274 has an inner portion 275 having slightly less thickness than the outer portion, thus creating a shallow annular cavity 312 (shown in FIG. 18) that will allow oil to flow from the bearings to lubricate the contact area between the ring 270 and scotch yoke 258, and the thrust washer 274.

In the V-4 cylinder configuration of the exemplary embodiment, each crankpin is connected to two pistons via scotch yokes. Thus, two scotch yokes, each riding on a bearing 262, ring 270, and spring clamps 272 as depicted in FIG. 14, would be fitted onto the crankpin. Three thrust washers 274 would be fitted on the crankpin: one between the two bearings, and one on the outward-facing side of each bearing. The center thrust washer between the two scotch yoke/bearing assemblies can have an inner portion 275 defining an annular cavity 312 on each side of the thrust washer 274 (as seen in FIG. 18). Each of the two oil holes 282 in the crankpin 250 shown in FIG. 14 would be lined up with the oil groove 264 on one of the bearings 262 and supply oil to the bearing.

FIG. 16 shows the scotch yokes and bearing assemblies seated on the crankpin 250.

FIGS. 17 and 18 show side cutaway views of the crankshaft, bearings, and scotch yokes, illustrating the lubrication of the bearings by oil through the oil bores. By way of orientation, two power cylinders 32 are visible in FIG. 17, each containing a piston 36 connected to a piston rod 38. The piston rod 38 passes through the bottom cylinder head 46 and is joined to a scotch yoke (258, shown in cutaway cross-section) that fits around a crankpin 250 of the crankshaft 180. The crankshaft 180 is shown, held in place by engine block 34 and crankshaft bearings 300. The crankshaft bearings 300 can be any suitable type of bearing known to persons skilled in the art, such as journal bearings, and these crankshaft bearings 300 can be lubricated by pressurized oil delivered by a mechanical lubricator or oil pump. The oil bores 214, 216, 218, and 219, which are visible in the crankshaft 180, carry some of the oil from the crankshaft bearing 300 to the bearings 262 on the crankpin 250. The roller bearing 262 is fitted onto the crankpin 250, and the groove 264 on the inner surface is aligned with the oil bore 219 in the crankpin, thus allowing oil emerging through the oil bore 219 to be spread over the entire contact area between the bearing 262 and the crankpin 250. As explained above, the roller bearing 262 can include one or more oil holes to allow oil to lubricate the rollers inside the bearing (the internal structure of the roller bearing, including the separate inner and outer races and the rollers, are not shown in these figures). The two sets of bearing assemblies and scotch yokes on each crankpin are separated from each other and from the crankshaft lobes 186 and 188 by thrust washers 274, which can be made of bronze in an exemplary embodiment. The thrust washers 274 define a shallow annular cavity 312 surrounding the bearings into which oil may flow from the bearings to lubricate the contact area between the ring 270 and scotch yoke 258, and the thrust washer 274.

In an alternative embodiment of the present invention, the pistons can be joined to the crankshaft using a crosshead mechanism instead of scotch yokes. FIG. 19 shows an end cutaway view of the expansion motor 30 employing this crosshead embodiment. Note that the valve gear, including the valves, valve cylinders, rocker arms, and camshaft are not shown in FIG. 19 but can take the same form discussed elsewhere herein. In FIG. 19, the pistons 36 are visible inside the power cylinders 32. The piston rod 38 passes through the bottom cylinder head 46 and is joined to a crosshead 350. In the embodiment shown, the crosshead 350 has a cylindrical shape and slides along the interior walls of the cylinder 352, which forms the crosshead guide. This cylinder 352 can be an extension of the structure that forms the main power cylinder 32 within which the piston 36 reciprocates. The crosshead 350 and crosshead guide 352 can include a bearing such as a bronze bushing or linear ball bearings to reduce friction and wear as the crosshead 350 slides along the crosshead guide 352. Alternatively, other types of crosshead designs, such as an alligator crosshead or a multiple bearing crosshead, can be used.

The crosshead 350 is pivotally joined to a connecting rod 354 at point 356, and the other end of the connecting rod 354 is joined to the crankpin 358 on the crankshaft 360. A roller bearing of the type discussed above with reference to FIGS. 14 through 16 can be used at the interface of the connecting rod 354 and the crankpin 358, with the connecting rod 354 fitting over the outer race of the roller bearing, or over an outer ring that is fitted on the outer race of the roller bearing, as described above. Alternatively, a journal bearing can be used. Such journal bearing can be made of two semicircular halves that fit together over the crankpin, and the connecting rod can feature a split knuckle design, as known to persons skilled in the art, thus enabling the crankshaft to be made in one piece rather than in the three separate sections depicted in FIG. 13. Lubrication of the bearing for the connecting rod can be accomplished as discussed above with reference to FIGS. 17 and 18.

Having described the invention with reference to exemplary embodiments, it is to be understood that the invention is defined by the claims and is not intended that any limitations or elements describing the exemplary embodiment set forth herein are to be incorporated into the meanings of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

1. An expansion motor comprising:
at least one piston adapted to reciprocate upon application of force to the piston by pressurized gas; and
a rotating member coupled to the piston such that the reciprocating motion of the piston causes the rotating member to rotate; wherein
the pressurized gas is steam generated with the assistance of a heat transfer device in thermal communication with exhaust from an industrial process.

2. The expansion motor of claim 1, wherein
force is alternately applied to each of two opposing surfaces of the piston by the pressurized gas.

3. The expansion motor of claim 2, wherein
the industrial process is a manufacturing process.

4. The expansion motor of claim 2, wherein
the industrial process is the combustion of biomass material.

5. The expansion motor of claim 4, wherein
the biomass material is municipal solid waste.

6. The expansion motor of claim 4, wherein
the biomass material is landfill gas created by the decomposing of landfill municipal solid waste.

7. The expansion motor of claim 4, wherein
the biomass material is animal waste.

8. The expansion motor of claim 2, wherein
the piston reciprocates within a piston cylinder; and
during application of force to the piston by the pressurized gas, the pressurized gas is allowed to expand within the piston cylinder.

9. The expansion motor of claim 8, wherein
the pressurized gas is allowed to expand to approximately at least four times its initial volume within the piston cylinder while applying force to the piston.

10. The expansion motor of claim 8, wherein
after applying force to the piston, the gas is exhausted from the piston cylinder substantially at ambient atmospheric pressure.

11. The expansion motor of claim 1, wherein
the heat transfer device includes an evaporator coil into which water is injected.

12. The expansion motor of claim 11, further comprising:
a venturi nozzle coupled to the evaporator coil, the venturi nozzle having:
(a) a channel including a section of narrower width than the surrounding sections;
(b) an air inlet through which air can enter the channel; and
(c) an internal baffle in the channel around which water flowing through the channel can pass;
whereby water entering the venturi nozzle is mixed with air, and such mixture is injected into the evaporator coil.

13. The expansion motor of claim 11, wherein
force is alternately applied to each of two opposing surfaces of the piston by the pressurized gas.

14. The expansion motor of claim 13, wherein
the industrial process is a manufacturing process.

15. The expansion motor of claim 13, wherein
the industrial process is the combustion of biomass material.

16. The expansion motor of claim 13, wherein
the piston reciprocates within a piston cylinder; and
during application of force to the piston by the pressurized gas, the pressurized gas is allowed to expand within the piston cylinder.

17. The expansion motor of claim 16, wherein
the pressurized gas is allowed to expand to approximately at least four times its initial volume while applying force to the piston.

18. The expansion motor of claim 16, wherein
after applying force to the piston, the gas is exhausted from the piston cylinder substantially at ambient atmospheric pressure.

19. The expansion motor of claim 1, further comprising:
a plurality of pistons coupled to the rotating member and adapted to reciprocate upon application of force to the pistons by pressurized gas.

20. The expansion motor of claim 19, wherein
force is alternately applied to each of two opposing surfaces of each of the plurality of pistons by the pressurized gas.

21. The expansion motor of claim 20, wherein
each of the plurality of pistons reciprocates within one of a plurality of piston cylinders; and
during application of force to the piston by the pressurized gas, the pressurized gas is allowed to expand within the piston cylinder.

22. The expansion motor of claim 21, wherein
the heat transfer device includes an evaporator coil into which water is injected.

23. The expansion motor of claim 22, further comprising:
a venturi nozzle coupled to the evaporator coil, the venturi nozzle having:
(a) a channel including a section of narrower width than the surrounding sections;
(b) an air inlet through which air can enter the channel; and
(c) an internal baffle in the channel around which water flowing through the channel can pass;
whereby water entering the venturi nozzle is mixed with air, and such mixture is injected into the evaporator coil.

24. The expansion motor of claim 22, wherein
force is alternately applied to each of two opposing surfaces of the piston by the pressurized gas.

25. The expansion motor of claim 24, wherein
each of the plurality of pistons reciprocates within one of a plurality of piston cylinders; and
during application of force to the piston by the pressurized gas, the pressurized gas is allowed to expand while applying force to the piston.

26. The expansion motor of claim 25, wherein
the pressurized gas is allowed to expand to approximately at least four times its initial volume while applying force to the piston.

27. The expansion motor of claim 25, wherein
after applying force to the piston, the gas is exhausted from the piston cylinder substantially at ambient atmospheric pressure.

28-107. (canceled)

108. A method for expanding a gas to convert internal energy of the gas into mechanical work, the method comprising the steps of:
(a) opening a first valve to admit pressurized gas to a first chamber adjacent to a first surface of a piston, thereby allowing the pressurized gas to apply a force to the piston in a first direction;
(b) at the time of step (a), opening a second valve to allow gas to escape from a second chamber adjacent to a second surface of a piston, wherein the second surface of the piston is opposed to the first surface of the piston;
(c) closing the first valve to terminate the admission of pressurized gas to the first chamber;
(d) allowing the pressurized gas in the first chamber to expand as it continues to apply a force to the piston in the first direction;
(e) when the piston reaches the end of its stroke such that the first chamber is at its maximum volume, closing the second valve;
(f) a short time following step (e), opening a third valve to admit pressurized gas to the second chamber, thereby allowing the pressurized gas to apply a force to the piston in a second direction opposite to the first direction;
(g) at the time of step (f), opening a fourth valve to allow gas to escape from the first chamber;
(h) closing the third valve to terminate the admission of pressurized gas to the second chamber;
(i) allowing the pressurized gas in the second chamber to expand as it continues to apply a force to the piston in the second direction;
(j) when the piston reaches the end of its stroke such that the second chamber is at its maximum volume, closing the fourth valve; and
(k) repeating steps (a) through (j).

109. The method of claim 108, wherein
the pressurized gas is steam.

110. The method of claim 108, wherein
the steam is allowed to expand to four times its initial volume during step (d) and step (i) within one of the first and second chambers.

111. The method of claim 108, wherein
during step (b) and step (g), the gas is exhausted from one of the first and second chambers substantially at ambient atmospheric pressure.

112. The method of claim 108, wherein
the pressurized gas is received from the exhaust of a heat engine.

113. The method of claim 112, wherein
the pressurized gas is exhaust from an internal combustion engine.

114. The method of claim 108, wherein
the pressurized gas is a byproduct of an industrial process.

115. The method of claim 108, wherein
the pressurized gas is stored gas that was pressurized at an earlier time by the work output of a motor.

116. The method of claim 115, wherein
the motor is a windmill.

117. The method of claim 115, wherein
the motor extracts energy from the movement of tidal waters.

118. The method of claim 108, wherein
the pressurized gas is extracted from an underground reservoir.

119. The method of claim 108, wherein
the pressurized gas is carbon dioxide.

120. The method of claim 108, wherein
the pressurized gas is natural gas.

121. The method of claim 108, wherein
the pressurized gas is extracted from a geothermal energy source.

122. The method of claim 108, wherein
the valves are actuated by cam lobes on a camshaft.

123. The method of claim 122, wherein
the camshaft is driven by a crankshaft, which is coupled to the piston and rotates in response to the reciprocation of the piston.

124. The method of claim 108, further comprising the step of:
performing steps (a) through (k) using a plurality of sets of four valves, each set of four valves being associated with one of a plurality of pistons; wherein
the relative timing of the steps (a) through (k) is staggered for the plurality of pistons such that the power strokes (d) and (i) for the plurality of pistons are evenly distributed in time.

125. The method of claim 124, wherein
each of the valves is actuated by a cam lobe on a camshaft.

126. The method of claim 125, wherein
the camshaft is driven by a crankshaft, which is coupled to the plurality of pistons and rotates in response to the reciprocation of the pistons.

127. The method of claim 108, further comprising, continuously throughout steps (a) through (k), the act of:
allowing lubricating oil to flow through a bore inside a rotating shaft to an orifice in the surface of the shaft, at which point the lubricating oil can lubricate a bearing.

128-152. (canceled)
